(19) United States
(12) Patent Application Publication
(10) Pub. No.: US 2026/0187864 A1
(43) Pub. Date: Jul. 2, 2026

(54) GEOLOGICAL INTERPRETATION IN HYDROCARBON EXPLORATION

(71) Applicant: Saudi Arabian Oil Company, Dhahran (SA)

(72) Inventors: Ahmad Ihsan Ramdani, Dhahran (SA); Pavel Golikov, Dhahran (SA); Ezzedeen Osama Alfataierge, Dhahran (SA)

(21) Appl. No.: 19/008,524

(22) Filed: Jan. 2, 2025

(51) Int. Cl. G06T 11/00; G06T 11/20; G06V 10/774; G06V 10/82; G06V 20/13; G06V 20/70

(52) U.S. Cl. CPC G06T 11/10; G06T 11/23; G06V 10/774; G06V 10/82; G06V 20/13; G06V 20/70; G06T 2200/24

(57) ABSTRACT

Example methods and systems for geological interpretation in hydrocarbon exploration are disclosed. One example method includes obtaining a geological sketch of a first region, where the geological sketch includes a color-labeled image of the first region, and each color in the geological sketch represents a respective type of geological land cover in the first region. A first machine learning model is applied to convert the geological sketch into a first virtual satellite image of the first region. The first virtual satellite image is provided for geological interpretation of the first region.

### TECHNICAL FIELD

The present disclosure relates to computer-implemented methods and systems for geological interpretation in hydrocarbon exploration.

### BACKGROUND

Seismic data, geological interpretations, and/or geological concepts can be depicted in the context of present-day geomorphology. For example, satellite images of present-day carbonate platforms such as the Bahamas and Maldives archipelagos can be used as analogs to the seismic images of carbonate platforms in the geologic past. An interpreter can then rely on narrative descriptions and sketches to convey the geological interpretation of the present-day carbonate platforms. In some cases, the narrative descriptions may be subjective and only well understood by subject matter experts (SMEs). Conveying the geological interpretation and/or geological concepts to non-experts may need a realistic visual aid.

### SUMMARY

The present disclosure involves methods and systems for geological interpretation in hydrocarbon exploration. One example method includes obtaining a geological sketch of a first region, where the geological sketch includes a color-labeled image of the first region, and each color in the geological sketch represents a respective type of geological land cover in the first region. A first machine learning model is applied to convert the geological sketch into a first virtual satellite image of the first region. The first virtual satellite image is provided for geological interpretation of the first region.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, a first multiple satellite images of one or more regions are obtained. The first machine learning model is generated by using the first plurality of satellite images to train the first machine learning model.

In some implementations, a depositional environment of the first region is part of a plurality of depositional environments of the one or more regions.

In some implementations, generating the first machine learning model by using the first multiple satellite images to train the first machine learning model includes generating multiple satellite label images by labeling the first multiple satellite images using colors respectively associated with geological land covers in the first multiple satellite images, and generating the first machine learning model by using the first multiple satellite images and the multiple satellite label images to train the first machine learning model.

In some implementations, generating the first machine learning model by using the first multiple satellite images to train the first machine learning model includes generating a second multiple satellite images of the one or more regions based on the first multiple satellite images, and generating the first machine learning model by using the first multiple satellite images and the second multiple satellite images to train the first machine learning model.

In some implementations, generating the second multiple satellite images of the one or more regions based on the first multiple satellite images includes resizing the first multiple satellite images into multiple square images, and generating the second multiple satellite images of the one or more regions based on the multiple square images.

In some implementations, a seismic attribute map of the first region is obtained, where the seismic attribute map includes multiple seismic attributes of the first region. The second virtual satellite image is provided for the geological interpretation of the first region.

In some implementations, a third multiple satellite images of one or more regions are obtained. The second machine learning model is trained based on the third multiple satellite images.

In some implementations, providing the first virtual satellite image for the geological interpretation of the first region includes providing, through a graphical user interface (GUI), the first virtual satellite image for the geological interpretation of the first region.

In some implementations, the first machine learning model is a conditional generative adversarial network (CGAN).

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example system for generating virtual satellite images from geological sketches and/or seismic data, according to some implementations.

FIG. 2 illustrates an example of a sketch training module, according to some implementations.

FIG. 3 illustrates an example of an image manipulation module used in the sketch training module in FIG. 2, according to some implementations.

FIG. 4 illustrates an example of a Conditional Generative Adversarial Network (CGAN) training module used in the sketch training module in FIG. 2, according to some implementations.

FIG. 5 illustrates an example of a generator used in the CGAN training module in FIG. 4, according to some implementations.

FIG. 6 illustrates an example of a discriminator used in the CGAN training module in FIG. 4, according to some implementations.

FIG. 7 illustrates an example of a seismic training module, according to some implementations.

FIG. 8 illustrates an example of an image manipulation module used in the seismic training module in FIG. 7, according to some implementations.

FIG. 9 illustrates an example of CGAN training module used in the seismic training module in FIG. 7, according to some implementations.

FIG. 10 illustrates an example of a generator used in the CGAN training module in FIG. 9, according to some implementations.

FIG. 11 illustrates an example of a discriminator used in the CGAN training module in FIG. 9, according to some implementations.

FIG. 12 illustrates an example of another image manipulation module used in the seismic training module in FIG. 7, according to some implementations.

FIG. 13 illustrates an example of another CGAN training module used in the seismic training module in FIG. 7, according to some implementations.

FIG. 14 illustrates an example of a generator used in the CGAN training module in FIG. 13, according to some implementations.

FIG. 15 illustrates an example of a discriminator used in the CGAN training module in FIG. 13, according to some implementations.

FIG. 16 illustrates an example of a sketch model application module, according to some implementations.

FIG. 17 illustrates an example of a seismic model application module, according to some implementations.

FIG. 18 illustrates an example of a manual editing interface, according to some implementations.

FIG. 19A illustrates an example of a seismic attribute map, according to some implementations.

FIG. 19B illustrates an example of another seismic attribute map, according to some implementations.

FIG. 19C illustrates an example of a photorealistic satellite image rendition of the Luconia Platform in FIG. 19A, according to some implementations.

FIG. 19D illustrates an example of a photorealistic satellite image rendition of the Bacinella-Lithocodium buildup complex in FIG. 19B, according to some implementations.

FIG. 20 illustrates an example process of generating virtual satellite images for geological interpretation, according to some implementations.

FIG. 21 is a block diagram of an example computer system that can be used to provide computational functionalities associated with described algorithms, methods, functions, processes, flows, and procedures, according to some implementations.

FIG. 22 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

Geological interpretation related operations, for example, modern analog, geological conceptualization, geological visualization, and/or seismic interpretations, are operations regularly performed in hydrocarbon exploration. For example, geological interpretation of seismic data can be important for subsurface investigation during oil and gas exploration. However, geological interpretation may need subject-specific expertise for conceptualization and visualization. For example, expert interpreters can produce a map of seismic attributes from a carbonate platform environment and associate the produced seismic attribute map with geological features using verbal or written descriptions that only fellow subject matter experts may understand. Conveying the geological interpretation and/or geological concepts to non-experts may need a realistic visual aid.

This disclosure describes systems and methods for converting geological sketches and/or subject-specific seismic data interpretation (e.g., seismic attribute maps) into photorealistic (also referred to as virtual) artificial satellite images that can be presented and visualized for common use. The disclosed method can utilize satellite images of the present-day Earth as training data for machine learning models (e.g., generative deep learning models), seismic forward modeling, and/or high-resolution image enhancement to depict features in the geologic past. The disclosed method can include a graphical user interface (GUI) where geoscientists can manually edit the geological sketches, and the resulting artificial satellite images can be displayed in real time. The disclosed method can also be used to generate reservoir models or visualize stratigraphic depositional evolution reconstruction through geological time. In some cases, an accurate reservoir model can be constructed based on an accurate geological model. Industry-standard geological models can be constructed using a geostatistical method, for example, by distributing facies (e.g., rock types) within a sequence of stratigraphic frameworks using geostatistical distribution methods. The geostatistical method can be tailored to simulate the depositional environment of the geologic past, and may not match the geological reality. Consequently, the geological models can be difficult to visualize. The disclosed method can help construct the geological models by using modern-day satellite images as image guidance. Therefore, the geological models can be visualized with respect to their geological analogs. For example, a sinusoid function can be utilized to represent and reconstruct the channel facies system in a reservoir. The disclosed method can utilize satellite images from modern-day channel systems (e.g., the Amazon, the Ganges, and the Mahakam River) to construct a geological model of the channel reservoir rather than generate mathematical sinusoids. Not only will the geological model constructed be more realistic, but also the geological model can be displayed as a photorealistic virtual satellite image of said channel in each stratigraphic framework. In some cases, the disclosed method can combine generative deep learning, seismic forward modeling, and/or high-resolution image enhancement to convert geological interpretations, conceptual sketches, and/or seismic data into photorealistic artificial satellite images.

The disclosed systems and methods provide many advantages over existing systems. As an example, the disclosed method can convert the seismic attribute map into virtual satellite imagery as a visual aid for geological interpretation. The virtual satellite imagery can act as a visual aid for the interpreter and provide more visual clarity to convey the geological interpretation of seismic data rather than relying solely on expert opinions. Therefore, the disclosed methods can promote better integration between experts and non-experts alike. As another example, the disclosed method can generate virtual satellite images to facilitate better data presentation and visualization, especially for non-geoscientists.

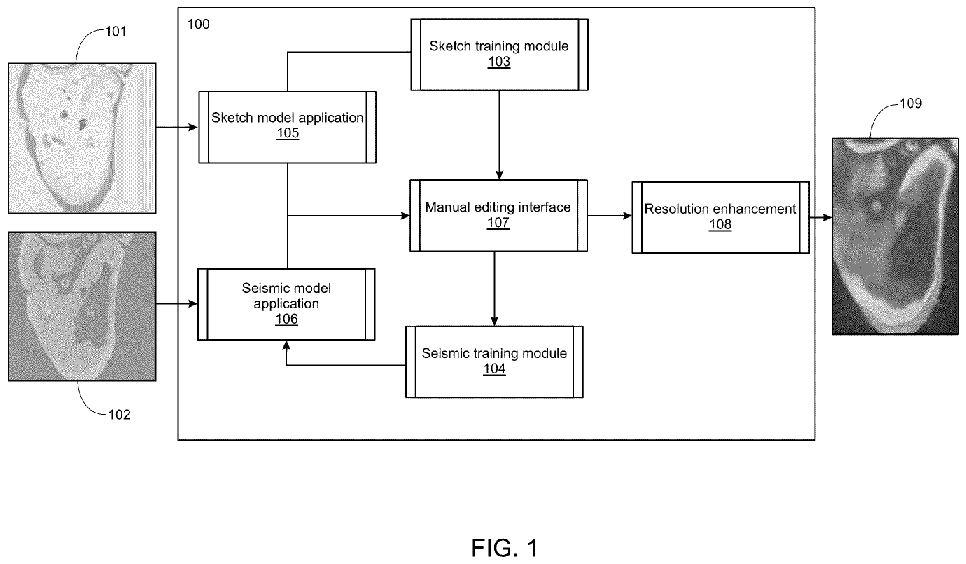

FIG. 1 illustrates an example system 100 for generating virtual satellite images from geological sketches and/or seismic data, according to some implementations. In some implementations, system 100 can convert input geological sketch 101, seismic attribute map 102, or a combination of input geological sketch 101 and seismic attribute map 102 into a photorealistic (also referred to as virtual) artificial satellite (also referred to as satellite) image 109. In some cases, seismic attribute map 102 can be a generic attribute term. For example, seismic attribute map 102 can represent quantities such as seismic amplitude, frequency, and/or phase, or more sophisticated quantities such as amplitude variations with offset (AVO) or spectral decomposition, as long as the quantities can be interpreted to depositional facies. System 100 can include a combination of sketch training module 103 and sketch model application 105, a combination of seismic training module 104 and seismic model application 106, manual editing interface 107, and/or resolution enhancement module 108. Input geological sketch 101 can be a color-labeled image where each color represents a respective type of geological land cover. For example, input geological sketch 101 shown in FIG. 1 is obtained from a carbonate platform environment. Different colors in input geological sketch 101 can represent different land covers. For example, if yellow, cyan, and purple colors are present in input geological sketch 101, yellow color can represent lagoons, cyan color can represent sand shoals, and purple color can represent barrier reefs. Input geological sketch 101 and seismic attribute map 102 can be from the same depositional environment or similar depositional environments when both input geological sketch 101 and seismic attribute map 102 are used as input to system 100. Example channel reservoir systems that have geological similarities can include the Amazon, the Ganges, and the Mahakam River. Example carbonate platform reservoir systems that have geological similarities can include the Bahamas and the Maldives. In some cases, the function of each module in system 100 can be performed on one or more central processing units (CPUs) or graphical processor units (GPUs). Two or more of the modules in FIG. 1 can be joined.

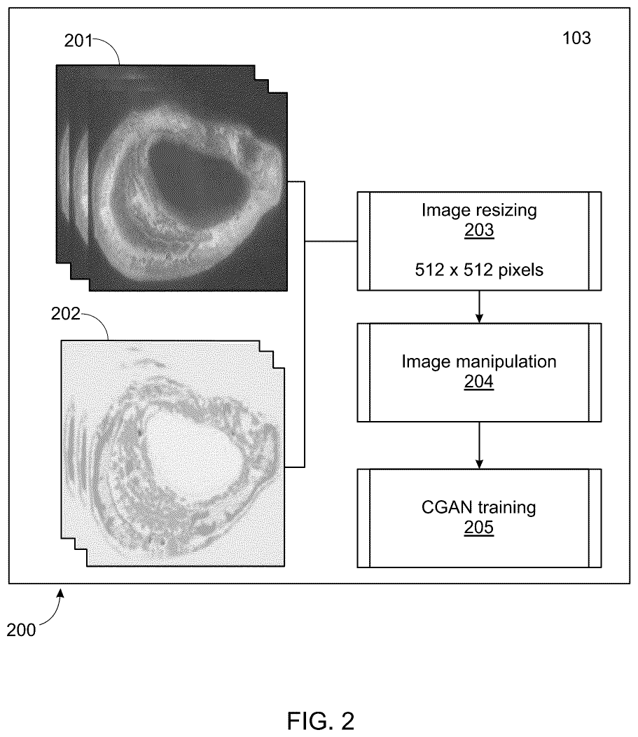

FIG. 2 illustrates an example 200 of sketch training module 103, according to some implementations. In some implementations, sketch training module 103 can provide a trained sketch model to convert a geological sketch 101 (defined as “label”), pixel-by-pixel, into a virtual satellite image 109. Sketch training module 103 can include satellite training images 201, satellite label images 202, image resizing module 203, image manipulation module 204, and/or a machine learning model (e.g., Conditional Generative Adversarial Network (CGAN)) training module 205.

In some implementations, the satellite training images 201 can be digital satellite photos of the Earth (e.g., from public or commercial databases), where the red-green-blue (RGB)-based colors of these photos represent the visible spectrum of electromagnetic waves. Examples of satellite training images 201 are the Google Earth® image and/or World Imagery by ESRI®. In some cases, the satellite training images 201 can be from a depositional environment similar to the depositional environment for input geological sketch 101 or seismic attribute map 102. In some cases, more satellite training images 201 provided to the sketch training module 103 can result in a more representative trained sketch model to convert geological sketches into virtual satellite images 109. In some cases, 40 satellite training images 201 can be used to run the sketch training module 103 to generate a trained sketch model.

In some implementations, the satellite label images 202 can be obtained by color-labeling satellite training images 201 according to the associated geological land covers. The color-labeling can be done manually by geologists or automatically using existing methods. In some cases, the color and geological land cover association of the satellite label images 202 can be similar to the color and geological land cover association of the input geological sketch 101. For example, if the purple color is present in the input geological sketch 101 and represents barrier reefs, the purple color can also be present in the satellite label images 202 and represent barrier reefs. In some cases, the automated labeling process can be an RGB color association between satellite training images 201 and satellite label images 202. For example, if an “open ocean” is shown in satellite training image 201 in FIG. 2 and has an RGB range of 29-51-72 to 31-64-81, an automated labeling process can associate the RGB range with RGB color 72-255-12 in a satellite label image 202. Another example of an automated labeling process is a Random Forest classification to increase the accuracy of the RGB color association.

In some implementations, image resizing module 203 may resize the satellite training images 201 and the associated satellite label images 202 into square images, for example, images with 512×512 pixels. If the satellite training images 201 and the associated satellite label images 202 are not square, the image resizing module 203 may crop or pad the satellite training images 201 and the associated satellite label images 202 into square images and then resize them into square images with a target size, e.g., 512×512 pixels. If the sizes of satellite training images 201 and associated satellite label images 202 are much larger than the target size (for example,1024×1024 pixels or 2048×2048 pixels, instead of 512×512 pixels), image resizing module 203 may split satellite training images 201 and associated satellite label images 202 into smaller patches of square images of the target size.

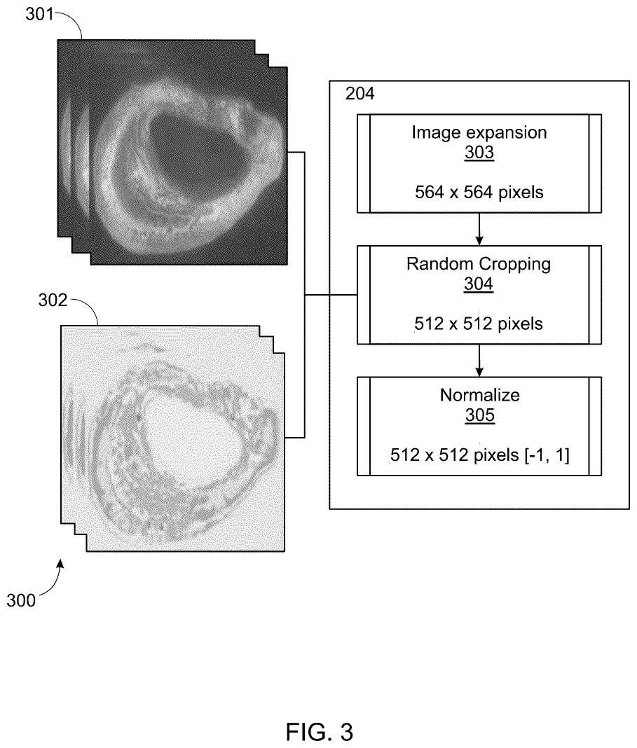

FIG. 3 illustrates an example 300 of image manipulation module 204, according to some implementations. In some implementations, image manipulation module 204 can be used to increase the number of training images used in CGAN training module 205. Input to image manipulation module 204 can be resized satellite training images 301 and resized satellite label images 302 from image resizing module 203. In some implementations, resized satellite training images 301 can be satellite training images 201 resized from their original sizes into a target size (e.g., 512×512 pixels). The resized satellite label images 302 can be satellite label images 202 resized from their original sizes into a target size (e.g., 512×512 pixels). Resized satellite training images 301 and resized satellite label images 302 are the output of image resizing module 203.

In some implementations, image manipulation module 204 can include image expansion module 303, random cropping module 304, and normalization module 305. In some implementations, the image expansion module 303 can expand resized satellite training images 301 and resized satellite label images 302 from a target size (e.g., 512×512 pixels) into a second target size (e.g., 564×564 pixels) using different methods, for example, the nearest neighbor method. Random cropping module 304 may randomly crop the expanded training images and the expanded label images back into the target size (e.g., 512×512 pixels).

In some implementations, normalization module 305 can convert the RGB-based color values of images, for example, resized satellite training images 301, resized satellite label images 302, and/or the randomly cropped images from random cropping module 304, into a normalized range, for example, a range of −1 to 1.

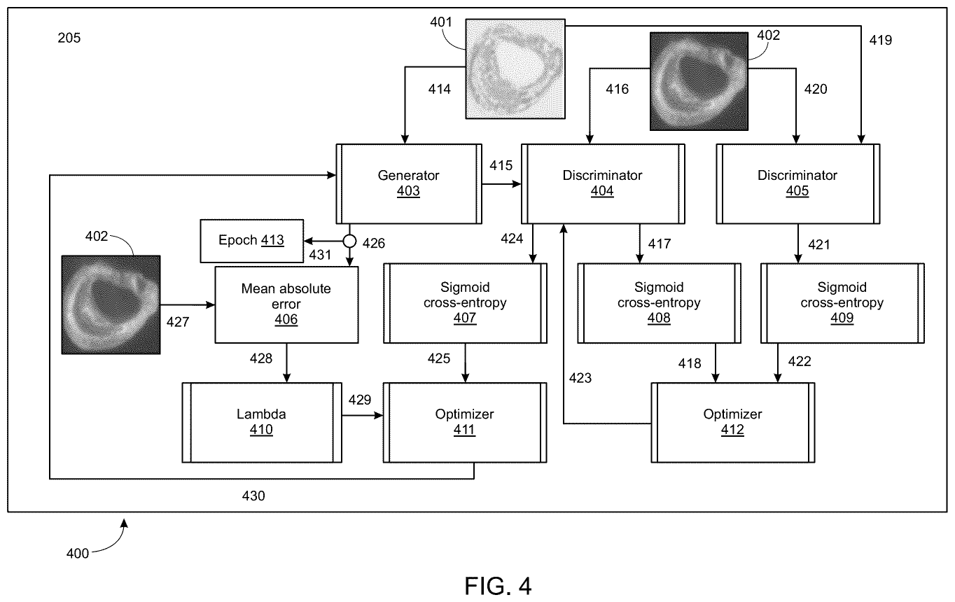

FIG. 4 illustrates an example 400 of CGAN training module 205, according to some implementations. In some implementations, CGAN training module 205 can be based on the U-net architecture and the pix2pix CGAN methods. The normalized satellite label images 401 and normalized satellite training images 402 can be the output of normalization module 305 in image manipulation module 204. A normalized satellite label image 401 can be the input to generator 403 and discriminator 405. A normalized satellite training image 402 can be the input to discriminator 404 and mean absolute error 406. Sigmoid cross-entropy 407 can be the product between the output of discriminator 404 and an array of ones. Sigmoid cross-entropy 408 can be the product between the output of discriminator 404 and an array of zeroes. Sigmoid cross-entropy 409 can be the product between the output of discriminator 405 and an array of ones. Lambda 410 can be an objective CGAN function with a lambda constant (e.g., 100). Optimizer 411 and optimizer 412 can be Adam Solvers with a particular learning rate (e.g., 0.0002). Generator 403 can generate a synthetic image 415 similar to a normalized satellite training image 402, while discriminator 404 can evaluate the synthetic image 415 from generator 403. The training data flow in CGAN training module 205 can follow the sequence of 414-415-416-417-418-419-420-421-422-423-424-425-426-427-428-429-430-415-417-418-423-424-425-430-415-417, and continue looping until generator 403 produces synthetic images that discriminator 404 fails to distinguish from the normalized satellite training image 402. A complete CGAN training iteration is called an epoch 413. The training data flow can repeat for all available normalized satellite label images 401 and normalized satellite training images 402. CGAN training module 205 can be satisfied by a number of epochs, for example, by 800 to 1000 epochs. CGAN training module 205 can produce a trained CGAN model that translates a color-labeled image (e.g., input geological sketch 101 and/or seismic attribute map 102) into a virtual satellite image 109.

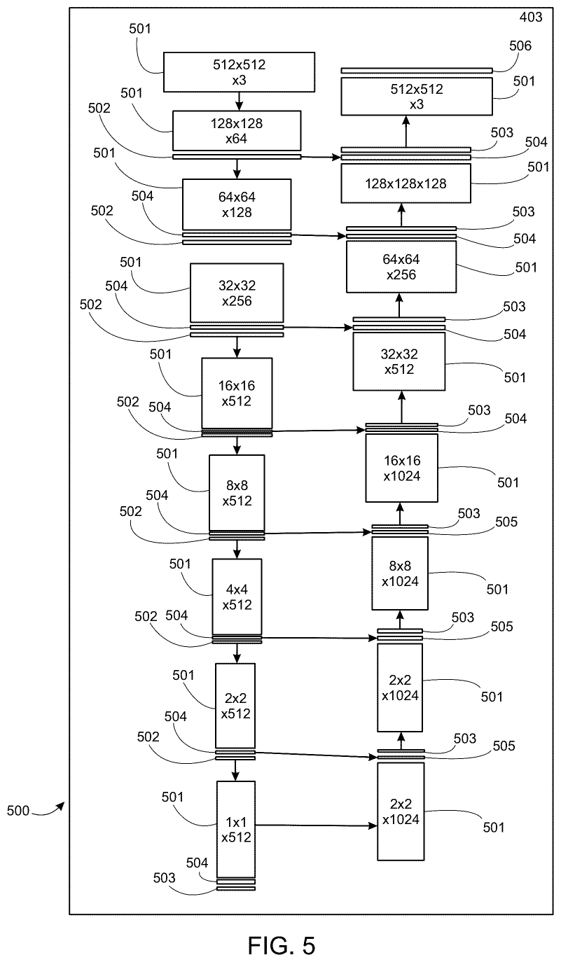

FIG. 5 illustrates an example 500 of generator 403 used in CGAN training module 205, according to some implementations. In some implementations, generator 403 can be a modified U-net architecture with spatial filters (e.g., 4×4 spatial filters), a stride (e.g., 2), a downward step and an upward step with corresponding factors (e.g., 2) (except for the first layer and the last layer), and skip connections.

In some implementations, each block 501 can represent the size of a convolutional neural network (CNN) layer. Each pass of a CNN layer can change the data size accordingly. The downward part of block 501 can be followed by leaky rectified linear unit (ReLU) activation function 502 with a slope (e.g., 0.2), while the upward part of block 501 can be followed by ReLU activation function 503. In some parts of block 501, batch normalization 504 or a combination of batch normalization 504 and dropout 505 can be applied before the activation function 502 or 503. The last upward block 501 can be applied Tanh function 506. The initial weight can be randomized using a Gaussian distribution with a mean (e.g., 0) and a standard deviation (e.g., 0.02).

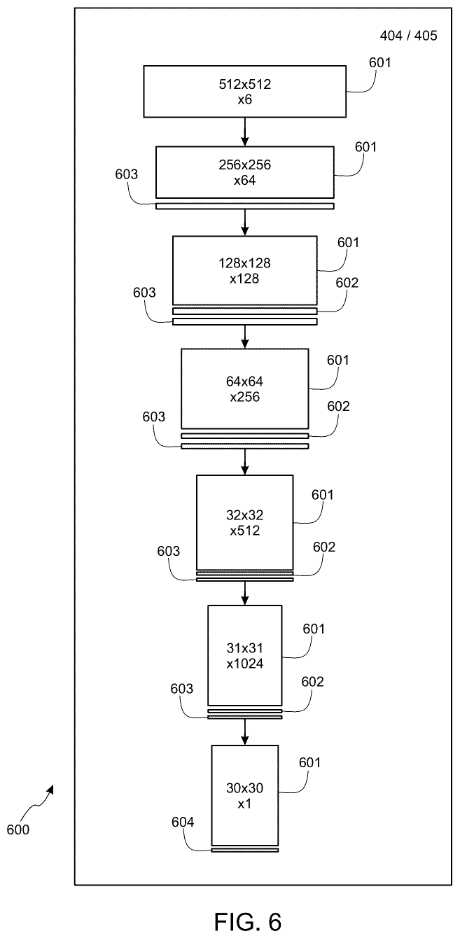

FIG. 6 illustrates an example 600 of discriminator 404 or discriminator 405 used in CGAN training module 205, according to some implementations. In some implementations, discriminator 404 and discriminator 405 have similar architectures and are modified convolutional neural networks (CNNs) that can perform patch-by-patch image evaluation. The difference between discriminator 404 and discriminator 405 is their inputs and outputs shown in FIG. 4. Referring to FIG. 6, the first CNN layer 601 can be a stack of the inputs. For example, normalized satellite label image 401 and normalized satellite training image 402 can be input to discriminator 405. If each input image is 512×512 pixels×3 RGB channels, the stacked input to discriminator 405 is 512×512 pixels×6 RGB channels. Each pass of the CNN layer 601 can change the data size. The size of the last CNN layer 601 can be 30×30 pixels×1 RGB channel, which evaluates 70×70 pixels of the inputs. In some cases, some CNN layers 601 can be followed by batch normalization 602, leaky ReLU activation function 603 with a slope (e.g., 0.2), and sigmoid activation function 604.

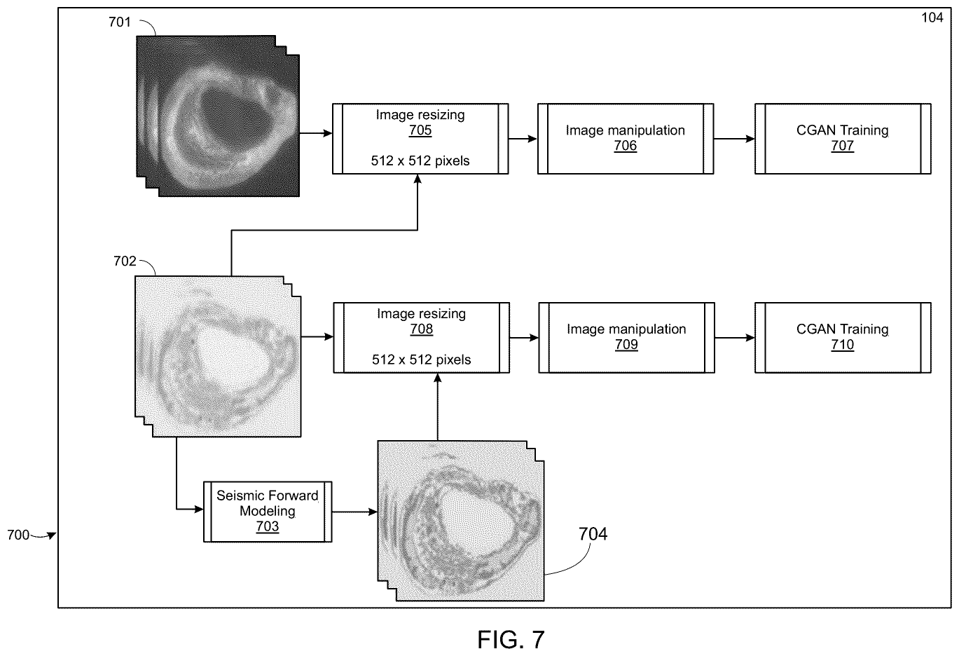

FIG. 7 illustrates an example 700 of seismic training module 104, according to some implementations. In some implementations, seismic training module 104 can provide a trained deep-learning seismic model to convert a seismic attribute map 102 (defined as “attribute”), pixel-by-pixel, into a virtual satellite image 109. Seismic training module 104 can include satellite seismic training images 701, satellite seismic label images 702, seismic forward modeling 703, synthetic seismic attribute map 704, image resizing module 705, image manipulation module 706, CGAN training module 707, image resizing module 708, image manipulation module 709, and/or CGAN training module 710.

In some implementations, similar to satellite training images 201, satellite seismic training images 701 can be present-day (on a geological scale) digital satellite photos of the Earth (e.g., from public or commercial databases), where the RGB-based colors of the photos represent the visible spectrum of electromagnetic waves. The satellite seismic training images 701 can be from a depositional environment similar to that of input geological sketch 101 or seismic attribute map 102.

In some implementations, the satellite seismic label images 702 can be obtained by color-labeling seismic satellite training images 701 according to the associated geological land covers. The color-labeling can be done manually by geologists or automatically using existing methods. In some cases, the color and geological land cover association of the seismic satellite label images 702 can be similar to the color and geological land cover association of the input geological sketch 101.

In some implementations, seismic forward modeling 703 may convert seismic satellite label images 702 into synthetic seismic attribute maps 704 using existing geophysical methods. An example geophysical method for the conversion includes assigning seismic property values (e.g., P-wave velocity, S-wave velocity, and density) to the depositional facies associated with seismic satellite label images 702. A convolution can be performed based on the seismic property values to compute synthetic seismic traces. The synthetic seismic traces can then be used to calculate seismic attributes (e.g., amplitude and frequency) in synthetic seismic attribute maps 704. In some cases, the type of synthetic seismic attribute maps 704 can be similar to that of seismic attribute maps 102. For example, if seismic attribute map 102 has zero offset reflection amplitude, then seismic forward modeling 703 generates synthetic seismic attribute maps 704 with zero offset reflection amplitude from satellite seismic label images 702. The seismic forward modeling 703 also assumes that depositional facies exert dominant control over the distribution of seismic properties.

In some implementations, image resizing modules 705 and 708 may resize the satellite seismic training images 701, satellite seismic label images 702, and synthetic seismic attribute maps 704 into square images, for example, images with 512×512 pixels. If the satellite seismic training images 701, satellite seismic label images 702, and/or the synthetic seismic attribute maps 704 are not square, image resizing modules 705 and 708 may crop or pad the non-square images into square images before resizing the cropped or padded images into square images of a target size, for example, images with 512×512 pixels. Image resizing modules 705 and 708 may also split the input images into smaller patches of square images with the target size (e.g., with size of 512×512 pixels), if the satellite seismic training images 701, satellite seismic label images 702, and/or synthetic seismic attribute maps 704 have sizes much larger than the target size.

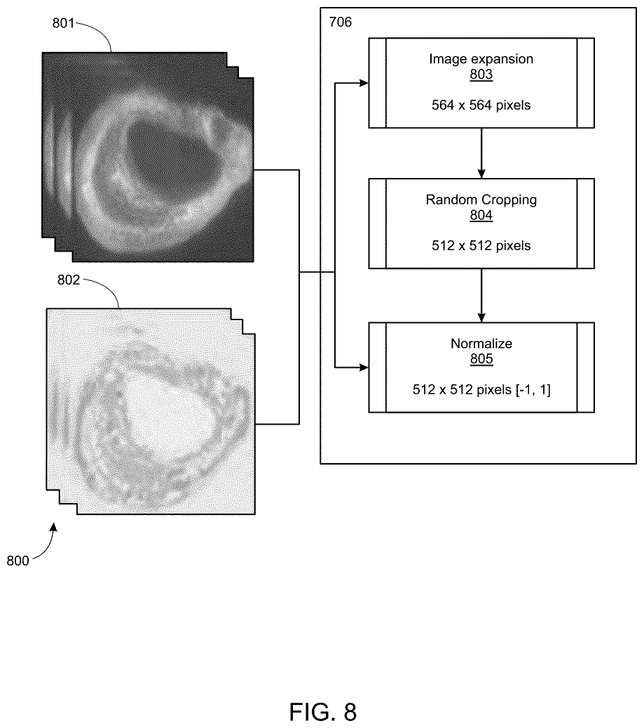

FIG. 8 illustrates an example 800 of image manipulation module 706, according to some implementations. In some implementations, image manipulation module 706 can have the same workflow as that of image manipulation module 204, but with different inputs. Input to image manipulation module 706 can be resized satellite seismic training images 801 (e.g., with sizes of 512×512 pixels) and resized satellite seismic label images 802 (e.g., with sizes of 512×512 pixels) from image resizing module 705. The image expansion module 803 may expand resized satellite seismic training images 801 and resized satellite seismic label images 802 from a target size (e.g., 512×512 pixels) into a second target size (e.g., 564×564 pixels) using different methods, for example, the nearest neighbor method. Random cropping module 804 may randomly crop the expanded satellite seismic training images and the expanded satellite seismic label images back into the target size (e.g., 512×512 pixels). Normalization module 805 can convert the RGB-based color values of images, for example, resized satellite seismic training images 801, resized satellite label images 802, and/or the randomly cropped images from random cropping module 804, into a normalized range, for example, a range of −1 to 1.

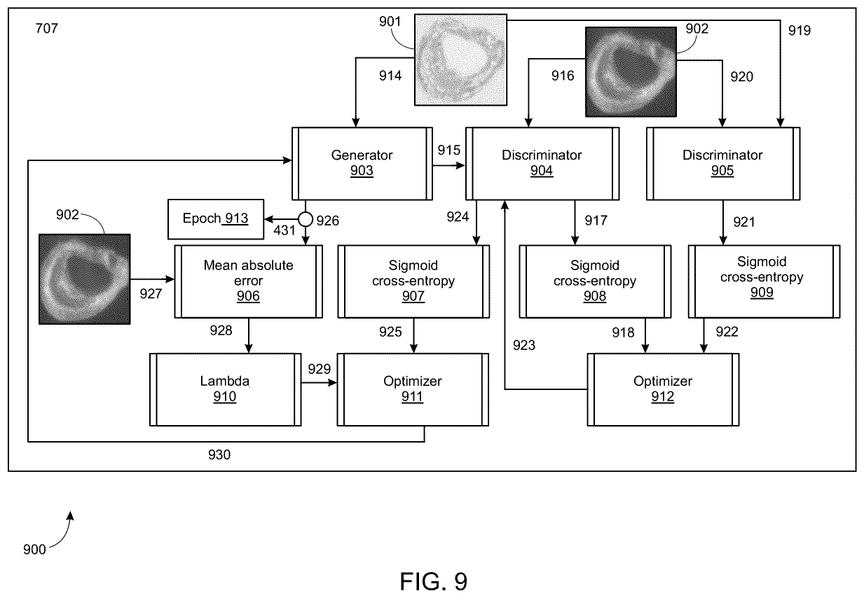

FIG. 9 illustrates an example 900 of CGAN training module 707, according to some implementations. In some implementations, CGAN training module 707 can have the same workflow as that of CGAN training module 205, but with different inputs. Therefore, CGAN training module 707 can also be based on the U-net architecture and modified pix2pix CGAN methods.

In some implementations, the normalized satellite seismic label images 901 and normalized satellite seismic training images 902 can be the output of normalization module 805 in image manipulation module 706. A normalized satellite seismic label image 901 can be the input to generator 903 and discriminator 905. A normalized satellite seismic training image 902 can be the input to discriminator 904 and mean absolute error 906. Sigmoid cross-entropy 907 can be the product between the output of discriminator 904 and an array of ones. Sigmoid cross-entropy 908 can be the product between the output of discriminator 904 and an array of zeroes. Sigmoid cross-entropy 909 can be the product between the output of discriminator 905 and an array of ones. Lambda 910 can be an objective CGAN function with a lambda constant (e.g., 100). Optimizer 911 and optimizer 912 can be Adam Solvers with a particular learning rate (e.g., 0.0002). Generator 903 can generate a synthetic image 915 similar to a normalized satellite seismic training image 902, while discriminator 904 can evaluate the synthetic image 915 from generator 903. The training data flow in CGAN training module 707 can follow the sequence of 914-915-916-917-918-919-920-921-922-923-924-925-926-927-928-929-930-915-917 -918-923-924-925-930-815-917, and continue looping until generator 903 produces synthetic images that discriminator 904 fails to distinguish from the normalized satellite seismic training image 902. A complete CGAN training iteration is called an epoch 913. The training data flow can repeat for all available normalized satellite seismic label images 901 and normalized satellite seismic training images 902. CGAN training module 707 can be satisfied by a number of epochs, for example, by 800 to 1000 epochs. CGAN training module 707 can produce a trained CGAN model that translates a seismic color-labeled image (e.g., input geological sketch 101 and/or seismic attribute map 102) into a virtual satellite image 109.

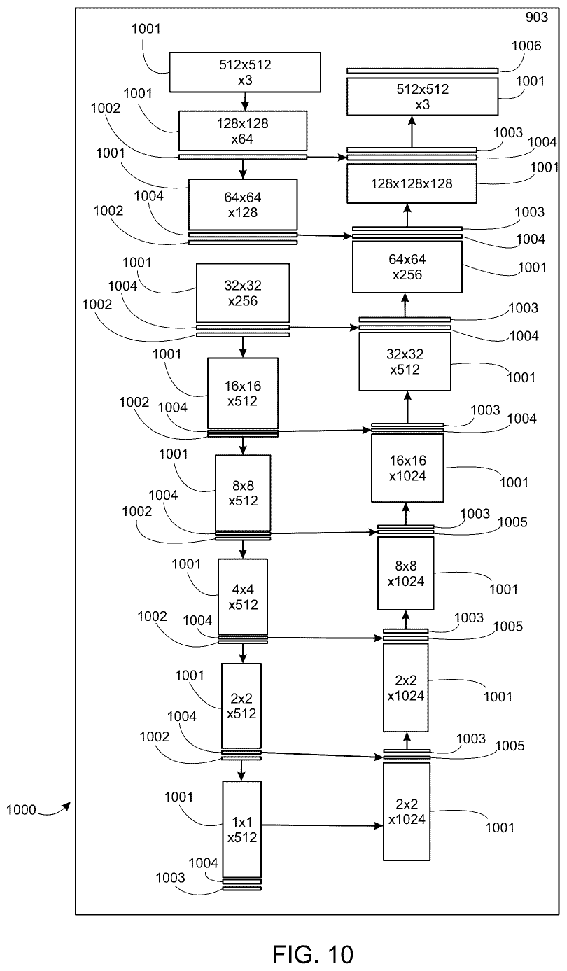

FIG. 10 illustrates an example 1000 of generator 903 used in CGAN training module 707, according to some implementations. In some implementations, generator 903 has the same workflow as that of generator 403, and can be a modified U-net architecture with spatial filters (e.g., 4×4 spatial filters), a stride (e.g., 2), a downward step and an upward step with corresponding factors (e.g., 2) (except for the first layer and the last layer), and skip connections.

In some implementations, each block 1001 in generator 903 can represent the size of a CNN layer. Each pass of a CNN layer can change the data size accordingly. The downward part of block 1001 can be followed by leaky ReLU activation function 1002 with a slope (e.g., 0.2), while the upward part of block 1001 can be followed by ReLU activation function 1003. In some parts of block 1001, batch normalization 1004 or a combination of batch normalization 1004 and dropout 1005 can be applied before the activation function 1002 or 1003. The last upward block 1001 can be applied Tanh function 1006. The initial weight can be randomized using a Gaussian distribution with a mean (e.g., 0) and a standard deviation (e.g., 0.02).

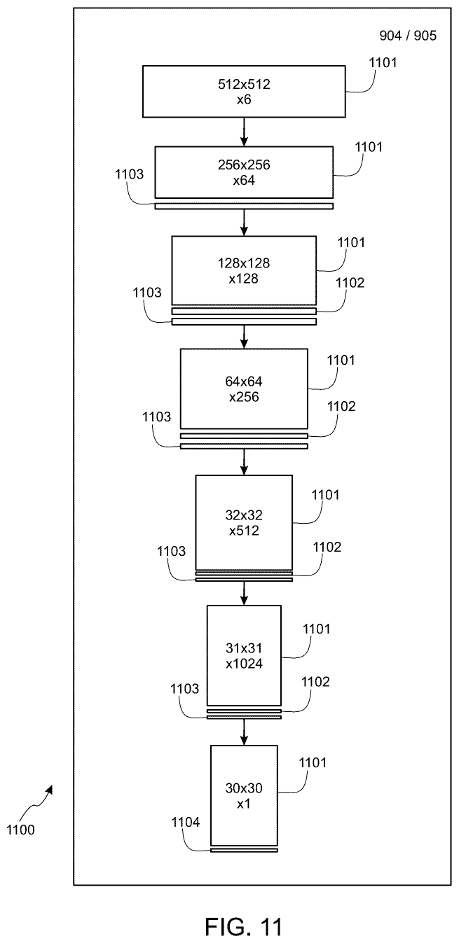

FIG. 11 illustrates an example 1100 of discriminator 904 or discriminator 905 used in CGAN training module 707, according to some implementations. In some implementations, discriminator 904 and discriminator 905 have the same workflows as those of discriminators 404 and 405, and are modified CNNs that can perform patch-by-patch image evaluation according to their input and output flows shown in FIG. 9. Referring to FIG. 11, the first CNN layer 1101 can be a stack of the input images to discriminator 904 or discriminator 905. For example, normalized satellite seismic label images 901 and normalized satellite seismic training images 902 can be input to discriminator 905. If each input image is 512×512 pixels×3 channel RGB, the stacked input to discriminator 905 is 512×512×6 channels. Each pass of the CNN layer 1101 can change the data size. The size of the last CNN layer 1101 can be 30×30×1, which evaluates 70×70 of the inputs. In some cases, some CNN layers 1101 can be followed by batch normalization 1102, leaky ReLU activation function 1103 with a slope (e.g., 0.2), and sigmoid activation function 1104.

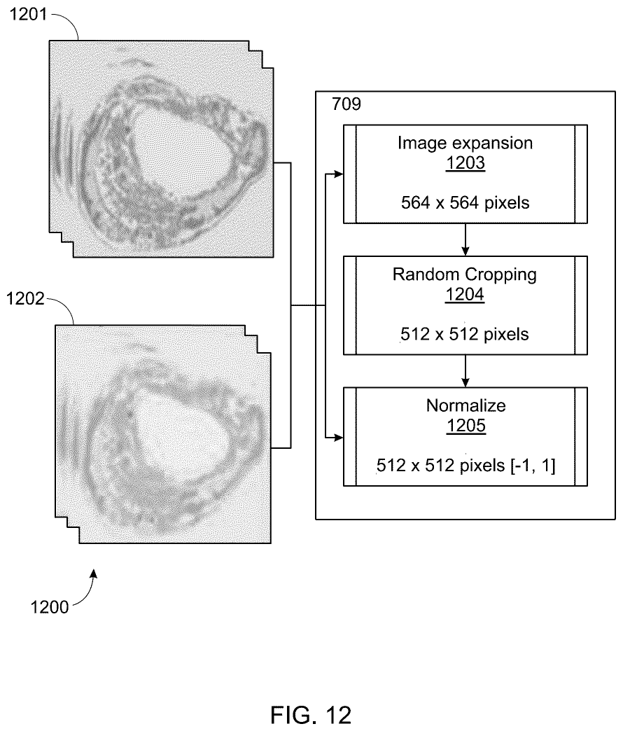

FIG. 12 illustrates an example 1200 of image manipulation module 709, according to some implementations. In some implementations, image manipulation module 709 can have the same workflow as those of image manipulation modules 204 and 706, but with different inputs. Input to image manipulation module 709 can be resized synthetic seismic attribute maps 1201 (e.g., with sizes of 512×512 pixels) and resized satellite seismic label images 1202 (e.g., with sizes of 512×512 pixels) from image resizing module 708. The image expansion module 1203 may expand resized synthetic seismic attribute maps 1201 and resized satellite seismic label images 1202 from a target size (e.g., 512×512 pixels) into a second target size (e.g., 564×564 pixels) using different methods, for example, the nearest neighbor method. Random cropping module 1204 may randomly crop the expanded synthetic seismic attribute maps and resized satellite seismic label images back into the target size (e.g., 512×512 pixels). Normalization module 1205 can convert the RGB-based color values of images, for example, resized synthetic seismic attribute map 1201, resized satellite seismic label images 1202, the randomly cropped synthetic seismic attribute maps, and/or the randomly cropped satellite seismic label images from random cropping module 1204, into a normalized range, for example, a range of −1 to 1.

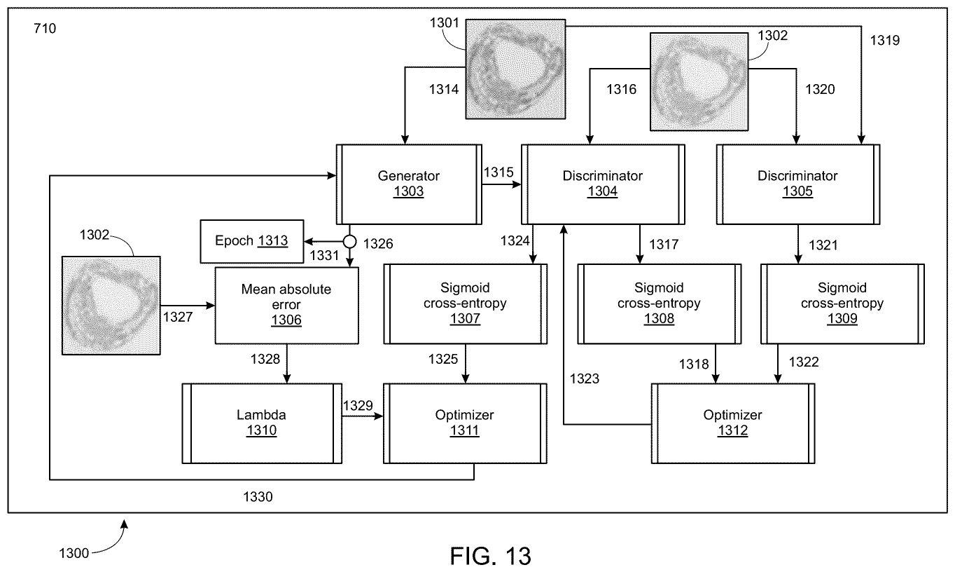

FIG. 13 illustrates an example 1300 of CGAN training module 710, according to some implementations. In some implementations, CGAN training module 710 has the same workflow as those of CGAN training modules 205 and 707, but with different inputs. CGAN training module 710 can be based on the U-net architecture and modified pix2pix CGAN methods.

In some implementations, normalized synthetic seismic attribute maps 1301 and normalized satellite seismic label images 1302 can be the output of normalization module 1205 in the image manipulation module 709. A normalized synthetic seismic attribute map 1301 can be the input to generator 1303 and discriminator 1305. A normalized satellite seismic label image 1302 can be the input to discriminator 1304 and mean absolute error 1306. Sigmoid cross-entropy 1307 can be the product between the output of discriminator 1304 and an array of ones. Sigmoid cross-entropy 1308 can be the product between the output of discriminator 1304 and an array of zeroes. Sigmoid cross-entropy 1309 can be the product between the output of discriminator 1305 and an array of ones. Lambda 1310 can be an objective CGAN function with a lambda constant (e.g., 100). Optimizer 1311 and optimizer 1312 can be Adam Solvers with a learning rate (e.g., 0.0002). Generator 1303 may generate a synthetic image 1315 similar to the normalized satellite seismic label image 1302, while discriminator 1304 may evaluate the synthetic image 1315 from generator 1303. The training data flow in CGAN training module 710 can follow the sequence of 1314-1315-1316-1317-1318-1319-1320-1321-1322-1323-1324-1325-1326-1327-1328-1329-1330-1315-1317-1318-1323-1324-1325-1330-1315-1317, and continue looping until generator 1303 produces synthetic images that discriminator 1304 fails to distinguish from the normalized satellite seismic label image 1302. A complete CGAN training iteration is called an epoch 1313. The training data flow repeated for all available normalized synthetic seismic attribute maps 1301 and normalized satellite seismic label images 1302. CGAN training module 710 can be satisfied by a number of epochs, for example, by 800 to 1000 epochs. CGAN training module 710 can produce a trained CGAN model that translates a seismic attribute map into a color-labeled image.

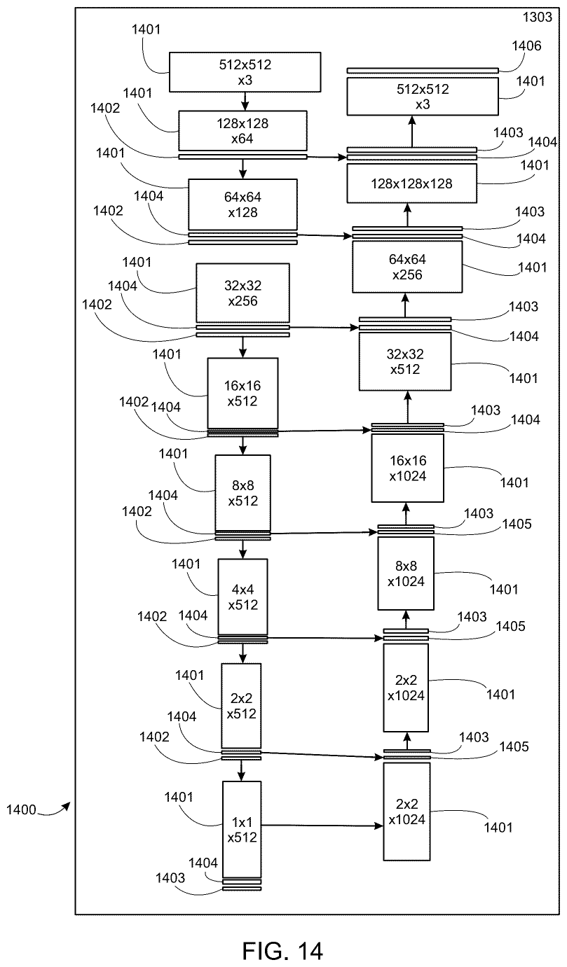

FIG. 14 illustrates an example 1400 of generator 1303 used in CGAN training module 710, according to some implementations. In some implementations, generator 1303 can have the same workflow as those of generators 403 and 903. Generator 1303 can have a modified U-net architecture with spatial filters (e.g., 4×4 spatial filters), a stride (e.g., 2), a downward step and an upward step with corresponding factors (e.g., 2) (except for the first layer and the last layer), and skip connections. In some implementations, each block 1401 can represent the size of a CNN layer. Each pass of a CNN layer can change the data size accordingly. The downward part of block 1401 can be followed by leaky ReLU activation function 1402 with a slope (e.g., 0.2), while the upward part of block 1401 can be followed by ReLU activation function 1403. In some parts of block 1401, batch normalization 1404 or a combination of batch normalization 504 and dropout 1405 can be applied before the activation function 502 or 503. The last upward block 1401 can be applied Tanh function 1406. The initial weight can be randomized using a Gaussian distribution with a mean (e.g., 0) and a standard deviation (e.g., 0.02).

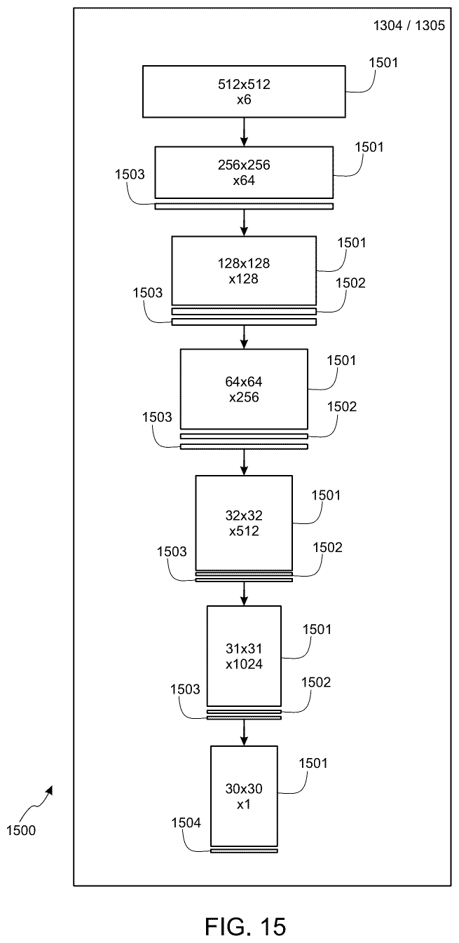

FIG. 15 illustrates an example 1500 of discriminator 1304 or discriminator 1305 used in CGAN training module 710, according to some implementations. In some implementations, discriminator 1304 and discriminator 1305 have the same workflows as those of discriminators 404 and 405, as well as discriminators 904 and 905, and are modified CNNs that can perform patch-by-patch image evaluation according to input and output flows shown in FIG. 13. Referring to FIG. 15, the first CNN layer 1501 can be a stack of inputs to discriminator 1304 or discriminator 1305. For example, normalized synthetic seismic attribute map 1301 and normalized satellite seismic label image 1302 can be input to discriminator 1305. If each normalized synthetic seismic attribute map 1301 or normalized satellite seismic label image 1302 is 512×512 pixels×3 channel RGB, the stacked input to discriminator 1305 is 512×512×6 channels. Each pass of the CNN layer 1501 can change the data size. The size of the last CNN layer 1501 can be 30×30×1, which evaluates 70×70 of the inputs. In some cases, some CNN layers 1501 can be followed by batch normalization 1502, leaky ReLU activation function 1503 with a slope (e.g., 0.2), and sigmoid activation function 1504.

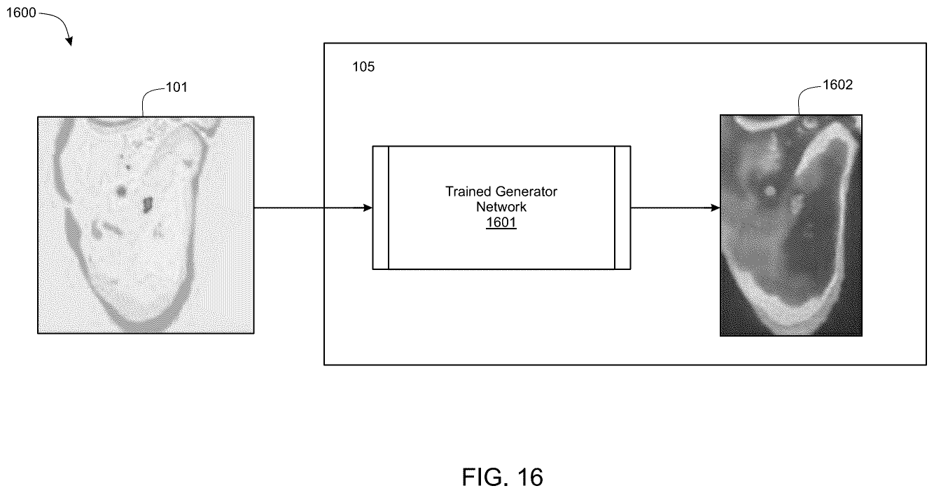

FIG. 16 illustrates an example 1600 of sketch model application module 105, according to some implementations. In some implementations, input to sketch model application module 105 can include geological sketch 101. Output from sketch model application module 105 can include virtual satellite image 1602 through the trained generator network 1601. Trained generator network 1601 can be generator 403 at the epoch number that satisfies the CGAN training module 205.

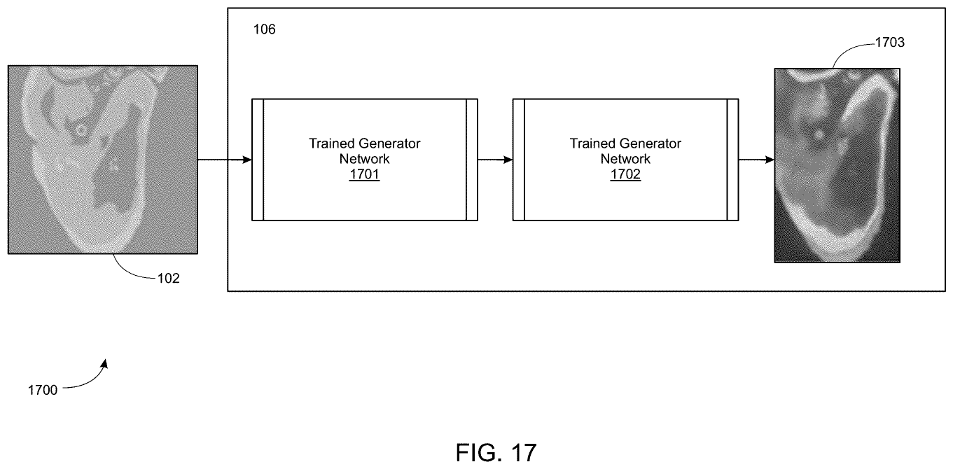

FIG. 17 illustrates an example 1700 of seismic model application module 106, according to some implementations. In some implementations, input to seismic model application module 106 can include seismic attribute map 102. Output from to seismic model application module 106 can include virtual satellite image 1703 through trained generator networks 1701 and 1702. Trained generator network 1701 can be generator 1303 at the epoch number that satisfies the CGAN training module 710. Trained generator network 1701 can translate the input seismic attribute map 102 into a color label. Trained generator network 1702 can be generator 903 at the epoch number that satisfies the CGAN training module 707. Trained generator network 1702 can translate the color label from the output of trained generator network 1701 into a virtual satellite image 1703.

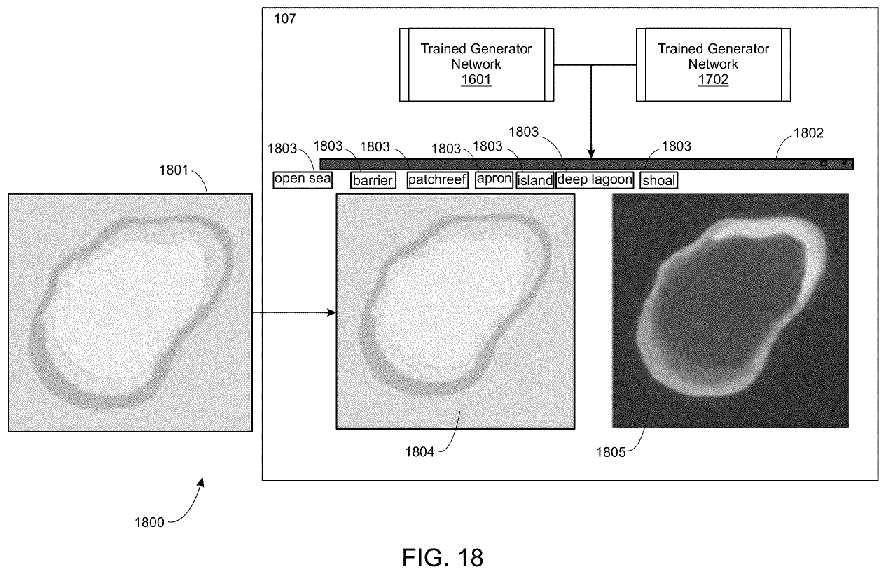

FIG. 18 illustrates an example 1800 of manual editing interface 107, according to some implementations. In some implementations, manual editing interface 107 can be a module for manually editing the resulting virtual satellite image 1602 or 1703, by editing the associated color label. Manual editing interface 107 can be skipped if a user is satisfied with virtual satellite image 1602 or 1703 resulting from sketch model application module 105 or seismic model application module 106 respectively. Manual editing interface 107 can use a graphical user interface with embedded trained generator network 1601 or 1702, depending upon the input to manual editing interface 107. Referring to FIG. 18, color label 1801 is the input to manual editing interface 107. In some cases, color label 1801 can be geological sketch 101 or a color-labeled seismic attribute map as an output from trained generator network 1701. Color label 1801 can be put into the sketching window 1804 within GUI 1802. If the input color label 1801 is geological sketch 101, then the trained generator network 1601 model is loaded to GUI 1802. If the input is a color-labeled seismic attribute map from trained generator network 1701, then the trained generator network 1702 model can be used in GUI 1802. The user can manually edit the color label 1801 by drawing in the sketching window 1804 through the geological land cover button 1803. The editing result can be displayed in real time as virtual satellite image in the virtual satellite image viewer 1805. GUI 1802 can also save the edited sketch and/or the edited virtual satellite image.

In some implementations, resolution enhancement module 108 can input virtual satellite images generated from sketch model application module 105, seismic model application module 106, or manual editing interface 107. Resolution enhancement module 108 can apply resolution enhancement using existing methods such as bicubic interpolation and/or EnhanceNet method to output resolution-enhanced virtual satellite image output 109.

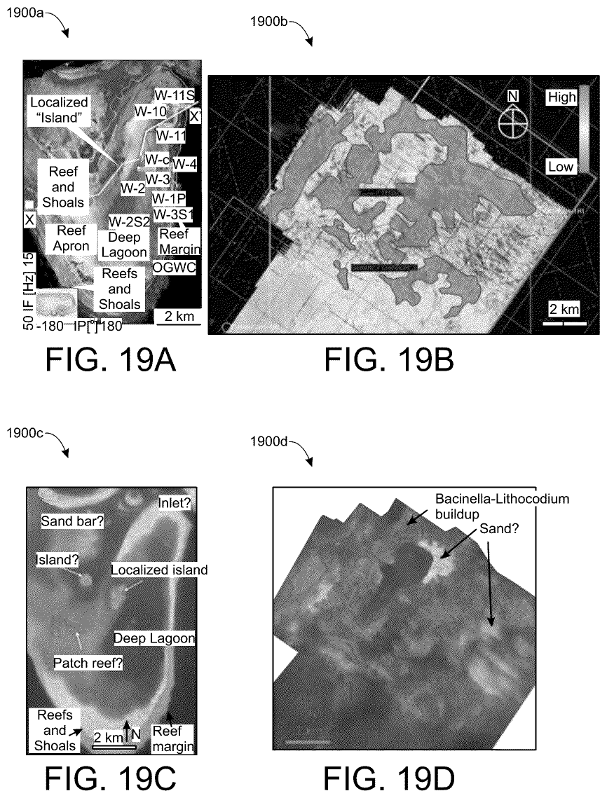

FIG. 19A illustrates an example 1900a of a seismic attribute map of instantaneous frequency vs. instantaneous phase of the Luconia Platform in offshore Malaysia, according to some implementations. FIG. 19A can be used to interpret the depositional facies of the Luconia Platform.

FIG. 19B illustrates an example 1900b of a root-mean-square (RMS) amplitude map (another type of seismic attribute map) of the Bacinella-Lithocodium reef buildup complex in Oman, according to some implementations. FIG. 19B can be used to interpret the outline of the Bacinella-Lithocodium reef buildup complex. The region shown in FIG. 19A or FIG. 19B can represent a heterogeneous depositional system in a shallow-water marine carbonate environment with different land covers, for example, barrier reefs, patch reefs, shoals, back-reef aprons, deep lagoons, and island facies belts in FIG. 19A and Bacinella-Lithocodium reef buildup and/or sand in FIG. 19B.

FIG. 19C illustrates an example 1900c of a photorealistic satellite image rendition of the Luconia Platform in FIG. 19A, according to some implementations. The photorealistic satellite image in FIG. 19C is converted from the seismic attributes map shown in FIG. 19A using the disclosed methods.

FIG. 19D illustrates an example 1900d of a photorealistic satellite image rendition of the Bacinella-Lithocodium buildup complex in FIG. 19B, according to some implementations. The photorealistic satellite image in FIG. 19D is converted from the RMS amplitude map shown in FIG. 19B using the disclosed methods. Open-source satellite images of modern tropical carbonate platforms in the South China Sea are used as training satellite images to train the machine learning models (e.g., generators 403, 903, and 1303) used in the disclosed methods. The photorealistic satellite image in FIG. 19C shows a photorealistic outline of the reef, shoal, lagoon, and island in the appropriate locations. The reef margin on the eastern side of the platform is thinning, following the overall structure of the seismic attribute in the same area. Widespread shoal and reef apron images are also rendered in FIG. 19C accordingly. The photorealistic satellite image in FIG. 19D shows a photorealistic outline of the buildup in the location where the RMS amplitude is higher than the background. Most of the high RMS amplitude areas in the localized bay area are rendered as sand with a more granular texture and brighter color. The sand is also rendered at the location where the buildup bends.

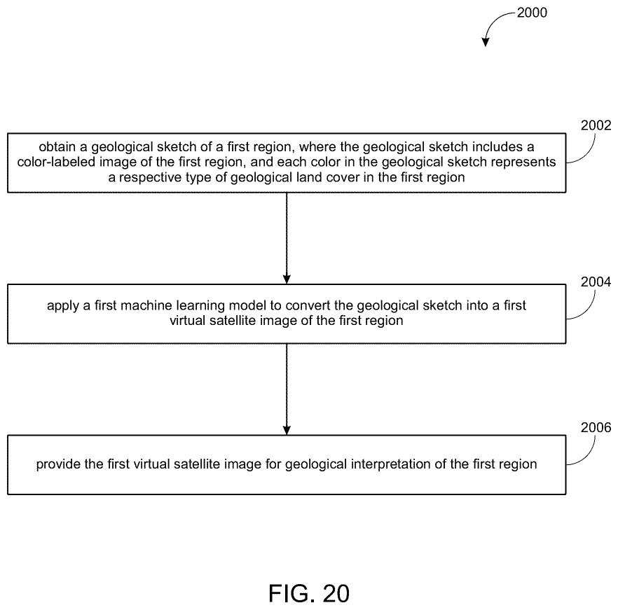

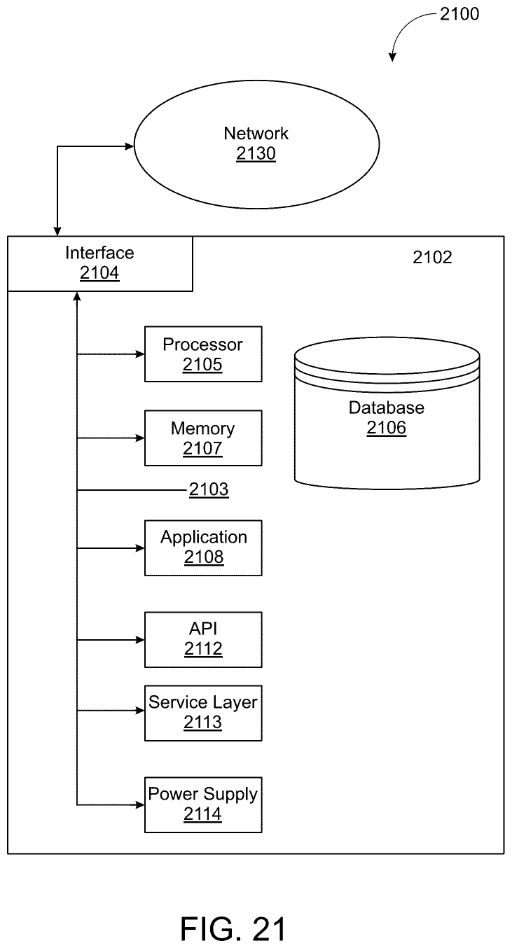

FIG. 20 illustrates an example process 2000 of generating virtual satellite images for geological interpretation, according to some implementations. For convenience, process 2000 will be described as being performed by a computer system having one or more computers located in one or more locations and programmed appropriately in accordance with this specification. An example of the computer system is the computer system 2100 illustrated in FIG. 21.

At 2002, a computer system obtains a geological sketch of a first region, where the geological sketch includes a color-labeled image of the first region, and each color in the geological sketch represents a respective type of geological land cover in the first region.

At 2004, the computer system applies a first machine learning model to convert the geological sketch into a first virtual satellite image of the first region.

At 2006, the computer system provides the first virtual satellite image for geological interpretation of the first region.

FIG. 21 is a block diagram of an example computer system 2100 that can be used to provide computational functionalities associated with described algorithms, methods, functions, processes, flows, and procedures, according to some implementations of the present disclosure. In some implementations, the computer system performing process 2000 can be the computer system 2100, include the computer system 2100, or the computer system performing process 2000 can communicate with the computer system 2100.

The illustrated computer 2102 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 2102 can include input devices such as keypads, keyboards, and touch screens that can accept user information. Also, the computer 2102 can include output devices that can convey information associated with the operation of the computer 2102. The information can include digital data, visual data, audio information, or a combination of information. The information can be presented in a GUI or other user interface. In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 2102 can include a Smart Embedded Management Agent (SEMA), such as a built-in ADLINK SEMA 2.2, and a video sync technology, such as Quick Sync Video technology supported by ADLINK MSDK+. In some examples, the computer 2102 can include the MXE-5400 Series processor-based fanless embedded computer by ADLINK, though the computer 2102 can take other forms or include other components.

The computer 2102 can serve in a role as a client, a network component, a server, a database, a persistency, or components of a computer system for performing the subject matter described in the present disclosure. The illustrated computer 2102 is communicably coupled with a network 2130. In some implementations, one or more components of the computer 2102 can be configured to operate within different environments, including cloud-computing-based environments, local environments, global environments, and combinations of environments.

At a high level, the computer 2102 is an electronic computing device operable to receive, transmit, process, store, and manage data and information associated with the described subject matter. According to some implementations, the computer 2102 can also include, or be communicably coupled with, an application server, an email server, a web server, a caching server, a streaming data server, or a combination of servers.

The computer 2102 can receive requests over network 2130 from a client application (for example, executing on another computer 2102). The computer 2102 can respond to the received requests by processing the received requests using software applications. Requests can also be sent to the computer 2102 from internal users (for example, from a command console), external (or third) parties, automated applications, entities, individuals, systems, and computers.

Each of the components of the computer 2102 can communicate using a system bus 2103. In some implementations, any or all of the components of the computer 2102, including hardware or software components, can interface with each other or the interface 2104 (or a combination of both), over the system bus. Interfaces can use an application programming interface (API) 2112, a service layer 2113, or a combination of the API 2112 and service layer 2113. The API 2112 can include specifications for routines, data structures, and object classes. The API 2112 can be either computer-language independent or dependent. The API 2112 can refer to a complete interface, a single function, or a set of APIs 2112.

The service layer 2113 can provide software services to the computer 2102 and other components (whether illustrated or not) that are communicably coupled to the computer 2102. The functionality of the computer 2102 can be accessible for all service consumers using this service layer 2113. Software services, such as those provided by the service layer 2113, can provide reusable, defined functionalities through a defined interface. For example, the interface can be software written in JAVA, C++, or a language providing data in extensible markup language (XML) format. While illustrated as an integrated component of the computer 2102, in alternative implementations, the API 2112 or the service layer 2113 can be stand-alone components in relation to other components of the computer 2102 and other components communicably coupled to the computer 2102. Moreover, any or all parts of the API 2112 or the service layer 2113 can be implemented as child or sub-modules of another software module, enterprise application, or hardware module without departing from the scope of the present disclosure.

The computer 2102 can include an interface 2104. Although illustrated as a single interface 2104 in FIG. 21, two or more interfaces 2104 can be used according to particular needs, desires, or particular implementations of the computer 2102 and the described functionality. The interface 2104 can be used by the computer 2102 for communicating with other systems that are connected to the network 2130 (whether illustrated or not) in a distributed environment. Generally, the interface 2104 can include, or be implemented using, logic encoded in software or hardware (or a combination of software and hardware) operable to communicate with the network 2130. More specifically, the interface 2104 can include software supporting one or more communication protocols associated with communications. As such, the network 2130 or the interface's hardware can be operable to communicate physical signals within and outside of the illustrated computer 2102.

The computer 2102 includes a processor 2105. Although illustrated as a single processor 2105 in FIG. 21, two or more processors 2105 can be used according to particular needs, desires, or particular implementations of the computer 2102 and the described functionality. Generally, the processor 2105 can execute instructions and manipulate data to perform the operations of the computer 2102, including operations using algorithms, methods, functions, processes, flows, and procedures as described in the present disclosure.

The computer 2102 can also include a database 2106 that can hold data for the computer 2102 and other components connected to the network 2130 (whether illustrated or not). For example, database 2106 can be an in-memory, conventional, or a database storing data consistent with the present disclosure. In some implementations, the database 2106 can be a combination of two or more different database types (for example, hybrid in-memory and conventional databases) according to particular needs, desires, or particular implementations of the computer 2102 and the described functionality. Although illustrated as a single database 2106 in FIG. 21, two or more databases (of the same, different, or combination of types) can be used according to particular needs, desires, or particular implementations of the computer 2102 and the described functionality. While database 2106 is illustrated as an internal component of the computer 2102, in alternative implementations, database 2106 can be external to the computer 2102.

The computer 2102 also includes a memory 2107 that can hold data for the computer 2102 or a combination of components connected to the network 2130 (whether illustrated or not). Memory 2107 can store any data consistent with the present disclosure. In some implementations, memory 2107 can be a combination of two or more different types of memory (for example, a combination of semiconductor and magnetic storage) according to particular needs, desires, or particular implementations of the computer 2102 and the described functionality. Although illustrated as a single memory 2107 in FIG. 21, two or more memories 2107 (of the same, different, or combination of types) can be used according to particular needs, desires, or particular implementations of the computer 2102 and the described functionality. While memory 2107 is illustrated as an internal component of the computer 2102, in alternative implementations, memory 2107 can be external to the computer 2102.

An application 2108 can be an algorithmic software engine providing functionality according to particular needs, desires, or particular implementations of the computer 2102 and the described functionality. For example, an application 2108 can serve as one or more components, modules, or applications 2108. Multiple applications 2108 can be implemented on the computer 2102. Each application 2108 can be internal or external to the computer 2102.

The computer 2102 can also include a power supply 2114. The power supply 2114 can include a rechargeable or non-rechargeable battery that can be configured to be either user-or non-user-replaceable. In some implementations, the power supply 2114 can include power-conversion and management circuits, including recharging, standby, and power management functionalities. In some implementations, the power-supply 2114 can include a power plug to allow the computer 2102 to be plugged into a wall socket or a power source to, for example, power the computer 2102 or recharge a rechargeable battery.

There can be any number of computers 2102 associated with, or external to, a computer system including computer 2102, with each computer 2102 communicating over network 2130. Further, the terms “client”, “user”, and other appropriate terminology can be used interchangeably without departing from the scope of the present disclosure. Moreover, the present disclosure contemplates that many users can use one computer 2102 and one user can use multiple computers 2102.

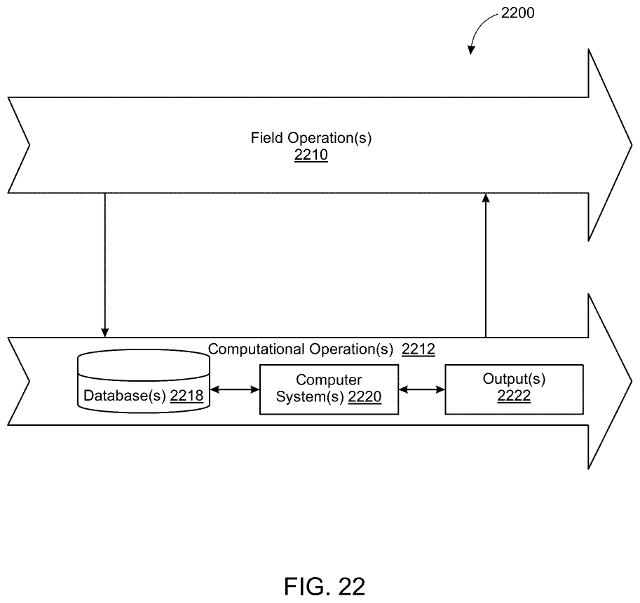

FIG. 22 illustrates hydrocarbon production operations 2200 that include both one or more field operations 2210 and one or more computational operations 2212, which exchange information and control exploration for the production of hydrocarbons, according to some implementations. In some implementations, outputs of techniques of the present disclosure can be performed before, during, or in combination with the hydrocarbon production operations 2200, specifically, for example, either as field operations 2210 or computational operations 2212, or both.

Examples of field operations 2210 include forming/drilling a wellbore, hydraulic fracturing, producing through the wellbore, injecting fluids (such as water) through the wellbore, to name a few. In some implementations, methods of the present disclosure can trigger or control the field operations 2210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 2210 and responsively triggering the field operations 2210 including, for example, generating plans and signals that provide feedback to and control physical components of the field operations 2210. Alternatively, or in addition, the field operations 2210 can trigger the methods of the present disclosure. For example, implementing physical components (including, for example, hardware, such as sensors) deployed in the field operations 2210 can generate plans and signals that can be provided as input or feedback (or both) to the methods of the present disclosure.

Examples of computational operations 2212 include one or more computer systems 2220 that include one or more processors and computer-readable media (e.g., non-transitory computer-readable media) operatively coupled to the one or more processors to execute computer operations to perform the methods of the present disclosure. The computational operations 2212 can be implemented using one or more databases 2218, which store data received from the field operations 2210 and/or generated internally within the computational operations 2212 (e.g., by implementing the methods of the present disclosure) or both. For example, the one or more computer systems 2220 process inputs from the field operations 2210 to assess conditions in the physical world, the outputs of which are stored in the databases 2218. For example, seismic sensors of the field operations 2210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 2212 where they are stored in the databases 2218 and analyzed by the one or more computer systems 2220.

In some implementations, one or more outputs 2222 generated by the one or more computer systems 2220 can be provided as feedback/input to the field operations 2210 (either as direct input or stored in the databases 2218). The field operations 2210 can use the feedback/input to control physical components used to perform the field operations 2210 in the real world.

For example, the computational operations 2212 can process the seismic data to generate three-dimensional maps of the subsurface formation. The computational operations 2212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 2212 to process new information about the formation and control the drilling to adjust to the observed conditions in real-time.

The one or more computer systems 2220 can update the 3D maps of the subsurface formation as information from one exploration well is received and the computational operations 2212 can adjust the location of the next exploration well based on the updated 3D maps. Similarly, the data received from production operations can be used by the computational operations 2212 to control components of the production operations. For example, production well and pipeline data can be analyzed to predict slugging in pipelines leading to a refinery and the computational operations 2212 can control machine operated valves upstream of the refinery to reduce the likelihood of plant disruptions that run the risk of taking the plant offline.

In some implementations of the computational operations 2212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### EMBODIMENTS

Embodiment 1: A computer-implemented method including obtaining a geological sketch of a first region, where the geological sketch includes a color-labeled image of the first region, and each color in the geological sketch represents a respective type of geological land cover in the first region. A first machine learning model is applied to convert the geological sketch into a first virtual satellite image of the first region. The first virtual satellite image is provided for geological interpretation of the first region.

Embodiment 2: The computer-implemented method of embodiment 1, further including obtaining a first multiple satellite images of one or more regions. The first machine learning model is generated by using the first plurality of satellite images to train the first machine learning model.

Embodiment 3: The computer-implemented method of embodiment 2, where a depositional environment of the first region is part of a plurality of depositional environments of the one or more regions.

Embodiment 4: The computer-implemented method of embodiment 2 or 3, where generating the first machine learning model by using the first multiple satellite images to train the first machine learning model includes generating multiple satellite label images by labeling the first multiple satellite images using colors respectively associated with geological land covers in the first multiple satellite images, and generating the first machine learning model by using the first multiple satellite images and the multiple satellite label images to train the first machine learning model.

Embodiment 5: The computer-implemented method of any one of embodiments 2 to 4, where generating the first machine learning model by using the first multiple satellite images to train the first machine learning model includes generating a second multiple satellite images of the one or more regions based on the first multiple satellite images, and generating the first machine learning model by using the first multiple satellite images and the second multiple satellite images to train the first machine learning model.

Embodiment 6: The computer-implemented method of embodiment 5, where generating the second multiple satellite images of the one or more regions based on the first multiple satellite images includes resizing the first multiple satellite images into multiple square images, and generating the second multiple satellite images of the one or more regions based on the multiple square images.

Embodiment 7: The computer-implemented method of any one of embodiments 1 to 6, further including obtaining a seismic attribute map of the first region, where the seismic attribute map includes multiple seismic attributes of the first region. The second virtual satellite image is provided for the geological interpretation of the first region.

Embodiment 8: The computer-implemented method of embodiment 7, further including obtaining a third multiple satellite images of one or more regions. The second machine learning model is trained based on the third multiple satellite images.

Embodiment 9: The computer-implemented method of any one of embodiments 1 to 8, where providing the first virtual satellite image for the geological interpretation of the first region includes providing, through a graphical user interface (GUI), the first virtual satellite image for the geological interpretation of the first region.

Embodiment 10: The computer-implemented method of any one of embodiments 1 to 9, where the first machine learning model is a conditional generative adversarial network (CGAN).

Embodiment 11: A non-transitory computer-readable medium storing one or more instructions executable by a computer system to perform operations including obtaining a geological sketch of a first region, where the geological sketch includes a color-labeled image of the first region, and each color in the geological sketch represents a respective type of geological land cover in the first region. A first machine learning model is applied to convert the geological sketch into a first virtual satellite image of the first region. The first virtual satellite image is provided for geological interpretation of the first region.

Embodiment 12: The non-transitory computer-readable medium of embodiment 11, where the operations further include obtaining a first multiple satellite images of one or more regions. The first machine learning model is generated by using the first plurality of satellite images to train the first machine learning model.

Embodiment 13: The non-transitory computer-readable medium of embodiment 12, where a depositional environment of the first region is part of a plurality of depositional environments of the one or more regions.

Embodiment 14: The non-transitory computer-readable medium of embodiment 12 or 13, where generating the first machine learning model by using the first multiple satellite images to train the first machine learning model includes generating multiple satellite label images by labeling the first multiple satellite images using colors respectively associated with geological land covers in the first multiple satellite images, and generating the first machine learning model by using the first multiple satellite images and the multiple satellite label images to train the first machine learning model.

Embodiment 15: The non-transitory computer-readable medium of any one of embodiments 12 to 14, where generating the first machine learning model by using the first multiple satellite images to train the first machine learning model includes generating a second multiple satellite images of the one or more regions based on the first multiple satellite images, and generating the first machine learning model by using the first multiple satellite images and the second multiple satellite images to train the first machine learning model.

Embodiment 16: A computer-implemented system, including one or more computers; and one or more computer memory devices interoperably coupled with the one or more computers and having tangible, non-transitory, machine-readable media storing one or more instructions that, when executed by the one or more computers, perform one or more operations including obtaining a geological sketch of a first region, where the geological sketch includes a color-labeled image of the first region, and each color in the geological sketch represents a respective type of geological land cover in the first region. A first machine learning model is applied to convert the geological sketch into a first virtual satellite image of the first region. The first virtual satellite image is provided for geological interpretation of the first region.

Embodiment 17: The computer-implemented system of embodiment 16, where the one or more operations further include obtaining a first multiple satellite images of one or more regions. The first machine learning model is generated by using the first plurality of satellite images to train the first machine learning model.

Embodiment 18: The computer-implemented system of embodiment 17, where a depositional environment of the first region is part of a plurality of depositional environments of the one or more regions.

Embodiment 19: The computer-implemented system of embodiment 17 or 18, where generating the first machine learning model by using the first multiple satellite images to train the first machine learning model includes generating multiple satellite label images by labeling the first multiple satellite images using colors respectively associated with geological land covers in the first multiple satellite images, and generating the first machine learning model by using the first multiple satellite images and the multiple satellite label images to train the first machine learning model.

Embodiment 20: The computer-implemented system of any one of embodiments 17 to 19, where generating the first machine learning model by using the first multiple satellite images to train the first machine learning model includes generating a second multiple satellite images of the one or more regions based on the first multiple satellite images, and generating the first machine learning model by using the first multiple satellite images and the second multiple satellite images to train the first machine learning model.

What is claimed is:

1. A computer-implemented method, comprising:
obtaining a geological sketch of a first region, wherein the geological sketch comprises a color-labeled image of the first region, and each color in the geological sketch represents a respective type of geological land cover in the first region;
applying a first machine learning model to convert the geological sketch into a first virtual satellite image of the first region; and
providing the first virtual satellite image for geological interpretation of the first region.

2. The computer-implemented method of claim 1, further comprising:
obtaining a first plurality of satellite images of one or more regions; and
generating the first machine learning model by using the first plurality of satellite images to train the first machine learning model.

3. The computer-implemented method of claim 2, wherein a depositional environment of the first region is part of a plurality of depositional environments of the one or more regions.

4. The computer-implemented method of claim 2, wherein generating the first machine learning model by using the first plurality of satellite images to train the first machine learning model comprises:
generating a plurality of satellite label images by labeling the first plurality of satellite images using colors respectively associated with geological land covers in the first plurality of satellite images; and
generating the first machine learning model by using the first plurality of satellite images and the plurality of satellite label images to train the first machine learning model.

5. The computer-implemented method of claim 2, wherein generating the first machine learning model by using the first plurality of satellite images to train the first machine learning model comprises:
generating a second plurality of satellite images of the one or more regions based on the first plurality of satellite images; and
generating the first machine learning model by using the first plurality of satellite images and the second plurality of satellite images to train the first machine learning model.

6. The computer-implemented method of claim 5, wherein generating the second plurality of satellite images of the one or more regions based on the first plurality of satellite images comprises:
resizing the first plurality of satellite images into a plurality of square images; and
generating the second plurality of satellite images of the one or more regions based on the plurality of square images.

7. The computer-implemented method of claim 1, further comprising:
obtaining a seismic attribute map of the first region, wherein the seismic attribute map comprises a plurality of seismic attributes of the first region;
applying a second machine learning model to convert the seismic attribute map into a second virtual satellite image of the first region; and
providing the second virtual satellite image for the geological interpretation of the first region.

8. The computer-implemented method of claim 7, further comprising:
obtaining a third plurality of satellite images of one or more regions; and
training the second machine learning model based on the third plurality of satellite images.

9. The computer-implemented method of claim 1, wherein providing the first virtual satellite image for the geological interpretation of the first region comprises:
providing, through a graphical user interface (GUI), the first virtual satellite image for the geological interpretation of the first region.

10. The computer-implemented method of claim 1, wherein the first machine learning model is a conditional generative adversarial network (CGAN).

11. A non-transitory computer-readable medium storing one or more instructions executable by a computer system to perform operations comprising:
obtaining a geological sketch of a first region, wherein the geological sketch comprises a color-labeled image of the first region, and each color in the geological sketch represents a respective type of geological land cover in the first region;
applying a first machine learning model to convert the geological sketch into a first virtual satellite image of the first region; and
providing the first virtual satellite image for geological interpretation of the first region.

12. The non-transitory computer-readable medium of claim 11, wherein the operations further comprise:
obtaining a first plurality of satellite images of one or more regions; and
generating the first machine learning model by using the first plurality of satellite images to train the first machine learning model.

13. The non-transitory computer-readable medium of claim 12, wherein a depositional environment of the first region is part of a plurality of depositional environments of the one or more regions.

14. The non-transitory computer-readable medium of claim 12, wherein generating the first machine learning model by using the first plurality of satellite images to train the first machine learning model comprises:
generating a plurality of satellite label images by labeling the first plurality of satellite images using colors respectively associated with geological land covers in the first plurality of satellite images; and
generating the first machine learning model by using the first plurality of satellite images and the plurality of satellite label images to train the first machine learning model.

15. The non-transitory computer-readable medium of claim 12, wherein generating the first machine learning model by using the first plurality of satellite images to train the first machine learning model comprises:
generating a second plurality of satellite images of the one or more regions based on the first plurality of satellite images; and
generating the first machine learning model by using the first plurality of satellite images and the second plurality of satellite images to train the first machine learning model.

16. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining a geological sketch of a first region, wherein the geological sketch comprises a color-labeled image of the first region, and each color in the geological sketch represents a respective type of geological land cover in the first region;
applying a first machine learning model to convert the geological sketch into a first virtual satellite image of the first region; and
providing the first virtual satellite image for geological interpretation of the first region.

17. The computer-implemented system of claim 16, wherein the one or more operations further comprise:
obtaining a first plurality of satellite images of one or more regions; and
generating the first machine learning model by using the first plurality of satellite images to train the first machine learning model.

18. The computer-implemented system of claim 17, wherein a depositional environment of the first region is part of a plurality of depositional environments of the one or more regions.

19. The computer-implemented system of claim 17, wherein generating the first machine learning model by using the first plurality of satellite images to train the first machine learning model comprises:
generating a plurality of satellite label images by labeling the first plurality of satellite images using colors respectively associated with geological land covers in the first plurality of satellite images; and
generating the first machine learning model by using the first plurality of satellite images and the plurality of satellite label images to train the first machine learning model.

20. The computer-implemented system of claim 17, wherein generating the first machine learning model by using the first plurality of satellite images to train the first machine learning model comprises:
generating a second plurality of satellite images of the one or more regions based on the first plurality of satellite images; and
generating the first machine learning model by using the first plurality of satellite images and the second plurality of satellite images to train the first machine learning model.
